(19) United States
(12) Patent Application Publication
(10) Pub. No.: US 2024/0307270 A1
(43) Pub. Date: Sep. 19, 2024

(54) ARTIFICIAL TEATS HAVING IMPROVED MILK FLOW CHARACTERISTICS

(71) Applicant: Ross Gordon MCINNES, Waipu (NZ)

(72) Inventor: Ross Gordon MCINNES, Waipu (NZ)

(21) Appl. No.: 18/577,869

(22) PCT Filed: Jul. 14, 2022
(86) PCT No.: PCT/NZ2022/050096

§ 371 Date: Jan. 9, 2024

(30) Foreign Application Priority Data
Jul. 14, 2021 (NZ) 778189
Oct. 8, 2021 (NZ) 781124

(51) Int. Cl. A61J 11/00

(52) U.S. Cl. CPC A61J 11/0035

(57) ABSTRACT

It is important for the healthy growth of infants or newborn animals that any artificial teats or nipples that are used to feed them, are designed to provide consistent and measured flow rates when in use. Slits in the end of artificial teats or nipples are often used to provide openings for milk flow, and the slits naturally close to seal the end of the teats or nipples when not in use. However, slits need to be carefully aligned with the suckling action of the infant or newborn animal for the milk to flow at a correct rate. An artificial teat with a number of slits, each orientated at a different angle, and which are situated within a generally circular shaped valley or ridge that is formed in the end of the artificial teat or nipple is also disclosed.

### FIELD OF THE INVENTION

This invention relates to an artificial teat, and in particular, but not exclusively to an artificial teat that is used for feeding an infant or a newborn animal.

### BACKGROUND

One of the key requirements of an artificial teat is its ability to control the rate at which an infant or a newborn animal is supplied with milk or a milk replacer, while it is suckling. In many cases, artificial teats either cause an infant or newborn animal to struggle to receive a sufficient flow, or they will receive a flow of milk at a rate faster than they can cope with. An insufficient flow rate can lead to frustration or to malnourishment, and a flow rate that is too fast can lead to difficulty swallowing and choking, and to over feeding and digestive problems.

Another key requirement of an artificial teat is durability. An artificial teat is repeatedly subjected to strenuous suckling action, and is vigorously cleaned after use. And to be suitable for the purpose of nursing a baby or a young animal, artificial teats need to be made from relatively soft elastomers. These conflicting requirements to be robust and durable, and yet soft and pliable, create difficulties that often lead to either poor performance from the outset, or a rapid degradation in performance after repeated use.

In an effort to meet these requirements of controlled flow rates, and teat durability (or consistency of flow rate during the life of an artificial teat), many different teat designs have been proposed and used over the years. Much of the design thought is focused on the type of opening that is formed in the nipple end of the artificial teat. The opening must work to some extent as a valve that will prevent the flow of milk until a suckling action causes it to open in a controlled manner.

Some have sought to solve this problem by providing a one-way valve in the body of the artificial teat. Milk can flow into a main cavity of the teat through the valve, and when the teat is squeezed by a suckling action, the milk in the cavity is prevented from flowing back towards its source by the one-way valve, and the pressure increases, causing a flow of pressurised milk out through an opening in the nipple end of the teat. However, being fed under pressure may not satisfy the infant's suckling urge, and can feed the infant at a faster rate than the infant is able to easily swallow.

In addition, the added complexity of an artificial teat with a one-way valve significantly increases the manufacturing cost, and makes the teat more difficult to clean. Any traces of milk that remain after cleaning can become a breeding ground for harmful bacteria that may later be passed on to the infant or young animal.

The type of opening in the nipple end of a teat, that has been found to be the most effective, is a simple slit that is cut through the elastomeric material that the teat is formed from. Such a slit, at least when it is initially cut, acts as a valve that will largely prevent a flow of milk from the teat, until the teat is exposed to a suckling action. In this way, a slit will often act as a control valve that can be very effective in helping to ensure that a nursing baby or young animal receives a drink in a desirable manner.

And within the range of feeding teats available today there are two main choices-a single slit, or a cross shaped slit. And while a slit is generally accepted as being the simplest and most effective form of flow control from the nipple end of an artificial teat, the use of a slit for this purpose comes with a significant disadvantage. The disadvantage is that the flow through a slit is significantly affected by the orientation of the slit relative to the suckling action of the child or animal.

Slits are generally sized and positioned in such a manner that the most desirable milk flow rate is achieved when the slit is aligned with the bite direction, or suckling action, of the infant or young animal. That is, when a baby, or a young calf is suckling, the slit should be aligned with the vertical centreline of their face.

With a cross shaped slit there is a greater chance of one of the slits being aligned with the bite direction, but even so, the feeding rate will still depend on how well the slit is aligned with the suckling action. And even if time is taken to carefully align the slit of a teat correctly, the baby or young animal may tilt its head while it is feeding, and the feeding rate will be affected. An infant is more likely to tilt it's head slightly to increase the feeding rate, and if the slit is not aligned perfectly, they will often tilt their heads even more to try and get more milk.

While feeding rates that are too slow, or that are too fast, have the potential to adversely affect all babies and young animals, the problems associated with differing feed rates is perhaps more immediately evident when feeding a number of young animals at the same time.

Research has shown the when groups of calves are fed at different feeding rates, calves that spent more time suckling had improved digestion of milk and superior weight gains when compared to faster fed calves (refer: Journal of Applied Animal Nutrition, Vol. 3: ell;

Influence of teat flow rate in commercial milk feeding systems on calf digestion and performance. McInnes et al).

The traditional feeding method in many farming regions has been to feed infant farm animals individually where different feeding rates due to teat orientation has traditionally been of little consequence. Animal welfare groups have been applying pressure to govemment legislators to pass laws requiring that infant farm animals be raised in pairs or groups to allow social interaction. Peer reviewed literature has shown advantages of group housing of infant farm animals (refer: J. Dairy Sci. 99:2453-2467: Effects of group housing of dairy calves on behavior, cognition, performance, and health. Costa et al).

As large numbers of infant farm animals are now being, or will soon to be, fed in pairs or groups, then a teat is required that can be applied quickly without the operator having to take time to check on teat orientation. If the paired animals are not feed at an even flow rate, the first animal finished will often push the other animal away from the slower feeding teat, and drink their milk. In this way the problem of drinking rates is further compounded by the problem of cross suckling after feeding, as one animal ends up overfed, and the other is underfed.

What is needed is an improved artificial teat, that not only promotes natural suckling, but which will also provide a consistent milk flow rate irrespective of teat orientation. The teat should also be durable, and provide the consistent flow rate even after multiple uses and repeated cleaning cycles.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge: or known to be relevant to an attempt to solve any problem with which this specification is concerned.

### OBJECT

It is therefore an object of the present invention to provide an artificial teat which will at least go some way towards overcoming one or more of the above-mentioned problems, or at least provide the public with a useful choice.

### STATEMENTS OF THE INVENTION

Accordingly, in a first aspect, the invention may broadly be said to consist in an artificial teat or nipple for feeding infants or newborn animals, the artificial teat having a base end, a nipple end, and a body section that is situated between the base end and the nipple end; and the artificial teat has a principal axis that passes through a centre of the base end and a centre of the nipple end; and at least part of the body section and of the nipple end is made of an elastomeric material; and the base end is configured so that the artificial teat is connectable to a feeding device or system, and an internal flow path is provided in the artificial teat to allow liquid to flow from the feeding device or system and through the body section to the nipple end; and the slits are each situated within a generally circular shaped valley or ridge that is formed in the nipple end.

Preferably the said generally circular shaped valley or ridge that is formed in the nipple end is centred about the principal axis of the artificial teat.

Preferably the said generally circular shaped valley or ridge has a first general radius of curvature that is different to, or is in an opposing direction to, a radius of curvature of the parts of the nipple end that surround, or which are surrounded by, the said generally circular shaped valley or ridge.

Preferably the nipple end has a central region which is surrounded by the said generally circular shaped valley or ridge.

Preferably the central region of the nipple end has a second general radius of curvature or has a conical shape.

Preferably a first direction of curvature of the said generally circular shaped valley or ridge is substantially opposite to a second direction of curvature of the central region.

Preferably the said generally circular shaped valley or ridge is concave if the central region is convex, or the said generally circular shaped valley or ridge is convex if the central region is concave.

Preferably the said generally circular shaped valley or ridge is in the form of a circular recessed channel having a concave curvature, when looking at the outer surface of the nipple end of the artificial teat.

Preferably the central region of the nipple end has a convex curvature when looking at the outer surface of the nipple end of the artificial teat.

Preferably the nipple end includes a plurality of slits that are each aligned in a substantially circumferential direction.

Preferably the nipple end includes a plurality of slits that each lie in a direction that is tangential to a circle that is formed by the base or bottom of the circular shaped valley, or to a circle that is formed by the crest of the circular shaped ridge.

Preferably the nipple end includes a plurality of slits that lie generally in the bottom of the generally circular shaped valley, or in the crest of the generally circular shaped ridge, that is formed in the nipple end.

Preferably the nipple end includes a plurality of slits that lie in a circular pattern that is centred about the principal axis of the artificial teat.

Optionally the nipple end includes a plurality of slits that are aligned radially with respect to the principal axis.

Preferably the artificial teat has an uneven number of slits.

Preferably the artificial teat has five or seven slits, and more preferably the artificial teat has five slits.

Preferably the artificial teat has five slits, and each slit is aligned at an angle in the range of sixty-five to eighty degrees, to two of the other slits.

Preferably the artificial teat has five slits, and each slit is aligned at an angle of approximately seventy-two degrees, or approximately one hundred and eight degrees, to two of the other slits.

Preferably the nipple end of the artificial teat has internal webs.

Preferably the webs are in the form of projecting internal walls that extend from an inside surface of the nipple end and toward the base end.

Preferably the internal webs are each radially aligned.

Preferably each internal web extends from the principal axis of the teat and out to a cylindrical sidewall of a body portion of teat.

Optionally the internal webs intersect and form a polygon having the same number of sides as the number of slits in the nipple end.

Optionally the internal webs span generally from one half of the inside of the nipple end to an opposing half of the inside of the nipple end.

Preferably the nipple end of the artificial teat has internal webs that pass through the locations of each of the radial slits.

Preferably the internal webs that pass through the locations of each of the radial slits are each aligned at right angles to a length of the slit associated to that internal web.

Preferably the slits are cut through the layer of elastomeric material that forms the outer surface of the nipple end and into the elastomeric material that forms the adjacent internal web or webs.

Preferably the slits are each aligned at right angles to the internal web associated with each slit.

Preferably the slits that are cut into the elastomeric material that forms the adjacent internal web material are slits that do not extend to a free edge of the internal web or webs.

Preferably the artificial teat has at least one slit assist member, or tear stopping member.

Preferably the artificial teat has at least one slit assist member, or tear stopping member, in the form of a centrally located slit assist member or tear stopping member that is situated in the central region.

Preferably the artificial teat includes at least one slit assist member, or tear stopping member, in the internal web or webs.

Preferably the central region of the nipple end has a thicker total wall thickness when compared to the wall thickness of the remainder of the nipple end.

Preferably the thicker total wall thickness of the central region of the nipple end is made up of a layer of the elastomeric material that forms at least part of the body section and of the nipple end, and the centrally located slit assist member or tear stopping member.

Preferably the centrally located slit assist member or tear stopping member is in the form of a substantially circular preformed member that is joined to the central region by an over-moulding process.

Preferably the slits in the nipple end do not extend inwardly to the centrally located slit assist member.

Preferably the or each slit assist member is configured to assist in keeping each of the slits closed.

Preferably the or each slit assist member is configured to assist by acting as a tear stopping device to slow down or stop the slits from tearing and increasing in size when the artificial teat is in use.

Preferably the artificial teat is formed by over-moulding the nipple end and at least a part of the body section over the or each slit assist member.

Preferably the or each slit assist member is made from the same, or a similar, elastomeric material as the remainder of the nipple end and at least a part of the body section.

Preferably the or each slit assist member is pre-tensioned during the time that the remainder of the nipple end and at least a part of the body section is over-moulded about the or each slit assist member.

Preferably the elastomeric material is an elastomeric material having a hardness according to the Shore A hardness scale of between forty and sixty.

In a second aspect, the invention may broadly be said to consist in a feeding device or system incorporating at least one artificial teat substantially as specified herein.

Preferably the feeding device or system is in the form of a feeding bottle, feeding trough, or feed delivery system.

The invention may also broadly be said to consist in the parts, elements and features referred to or indicated in the specification of the application, individually or collectively, and any or all combinations of any two or more of the parts, elements or features, and where specific integers are mentioned herein which have known equivalents, such equivalents are incorporated herein as if they were individually set forth.

### DESCRIPTION

Further aspects of the present invention will become apparent from the following description which is given by way of example only and with reference to the accompanying drawings in which:

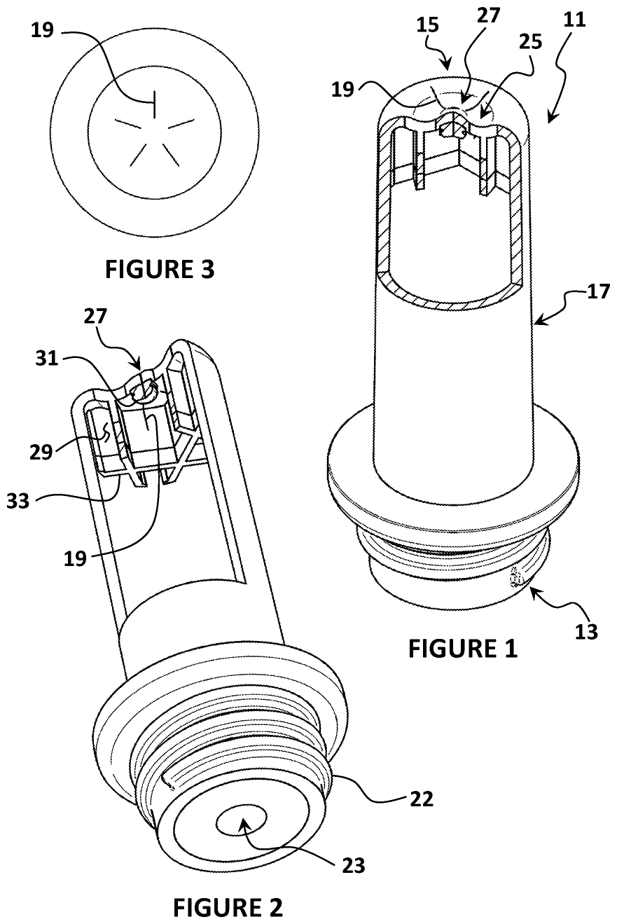

FIG. 1 is a partially cutaway perspective view of first example of an artificial teat according to the present invention,

FIG. 2 is a second partially cutaway view of the first example of an artificial teat,

FIG. 3 is a nipple end view of the first example of an artificial teat,

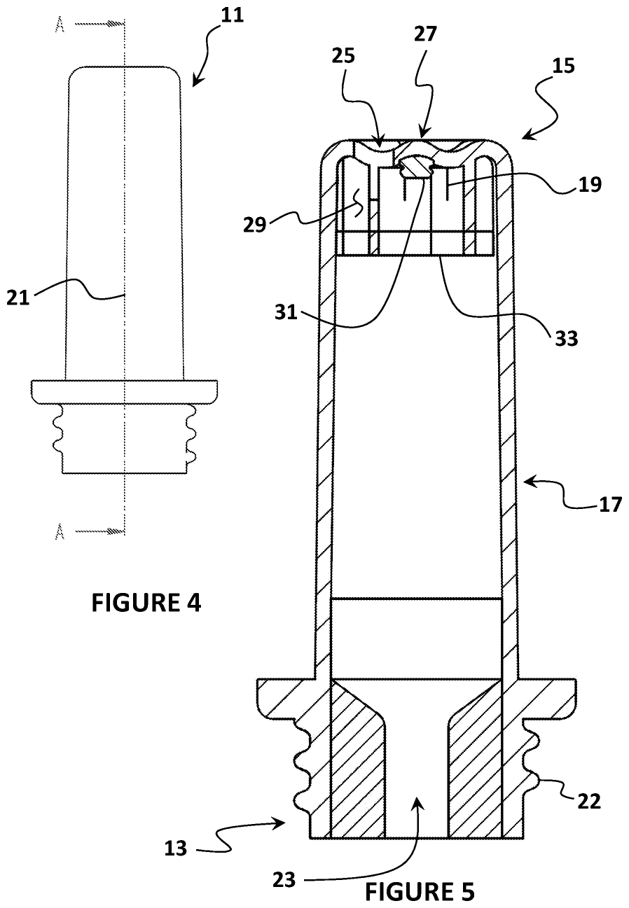

FIG. 4 is a top plan view of the first example of an artificial teat in which a cross sectional plane AA is defined,

FIG. 5 is cross sectional view AA of the first example of an artificial teat,

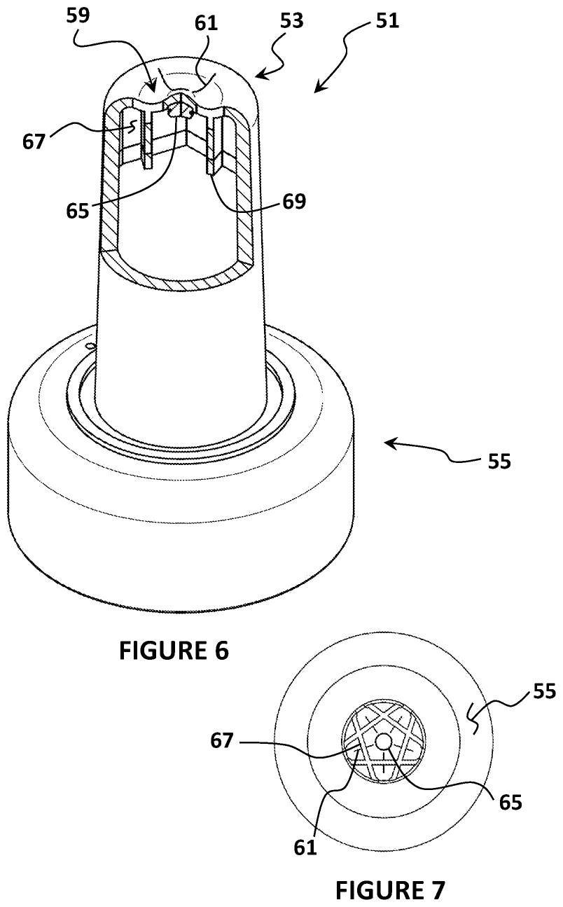

FIG. 6 is a partially cutaway perspective view of a second example of an artificial teat according to the present invention,

FIG. 7 is a base end view of the second example of an artificial teat,

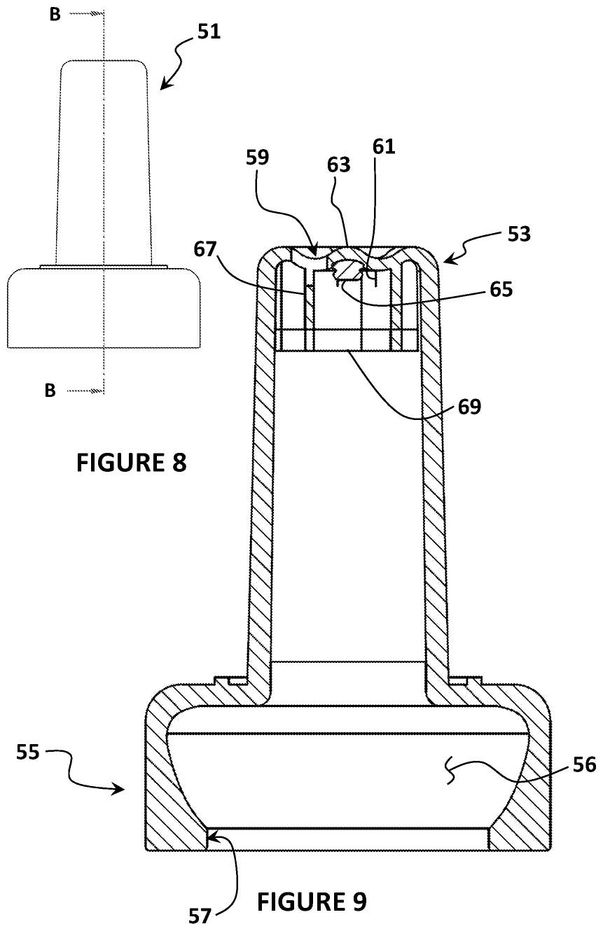

FIG. 8 is a top plan view of the second example of an artificial teat in which a cross sectional plane BB is defined,

FIG. 9 is cross sectional view BB of the second example of an artificial teat,

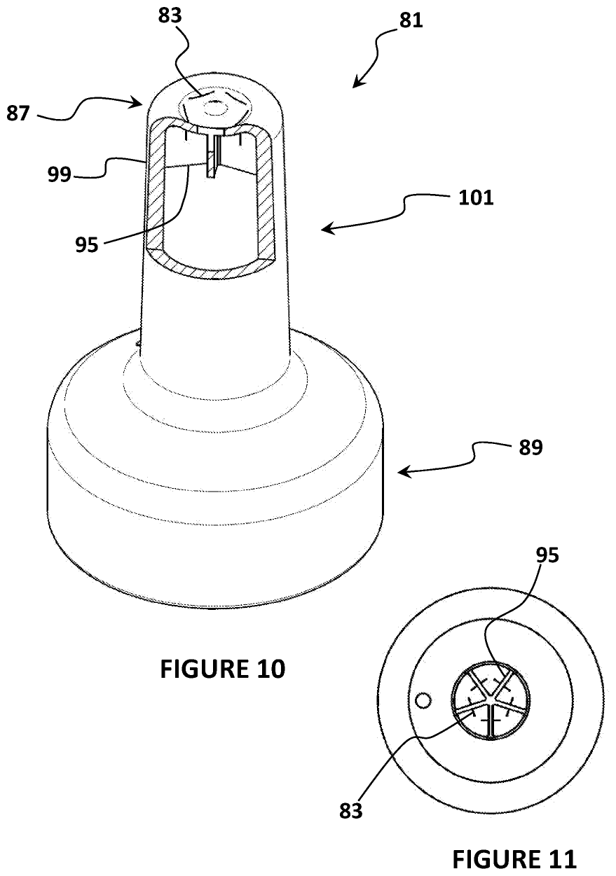

FIG. 10 is a partially cutaway perspective view of a third example of an artificial teat according to the present invention,

FIG. 11 is a base end view of the third example of an artificial teat,

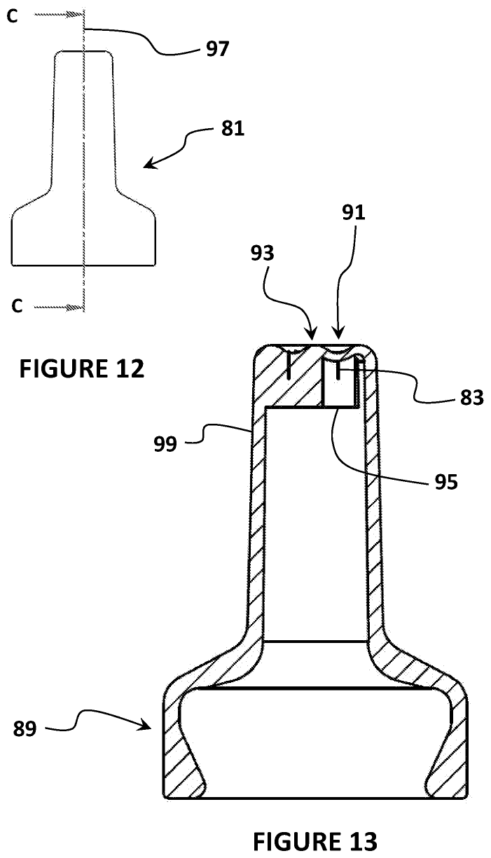

FIG. 12 is a top plan view of the third example of an artificial teat in which a cross sectional plane CC is defined, and

FIG. 13 is cross sectional view CC of the third example of an artificial teat.

### FIRST EXAMPLE

With reference to FIGS. 1 to 5, a first example of an artificial teat (11) according to the present invention will now be described. The artificial teat or nipple (11) has been designed for feeding infants or newborn animals, and is intended for use with feeding devices such as bottles or feeding troughs, or in larger scale feed delivery systems.

The artificial teat (11) has a base end (13), a nipple end (15), and a body section (17) that is situated between the base end (13) and the nipple end (15). And the artificial teat (11) has a principal axis (21) that passes through a centre of the base end (13) and a centre of the nipple end (15).

It is the nipple end (13) that contains the innovative features of the artificial teat (11). The nipple end (13) has a particular arrangement of slits (19), that are situated within a specifically designed contouring of the nipple end (13). The arrangement of the slits (19) and the contouring has been carefully designed to provide an accurate and consistent flow of milk to an infant or young animal, irrespective of the orientation of the nipple end (13) about the principal axis (21), and relative to the suckling action of the infant or young animal. In additional, structural features have been added to nipple end (13) to ensure that the advantages of this functional design feature remain throughout the design life of the teats (11).

While the base end (13) may take many forms to allow the artificial teat (11) to be connected to a bottle, trough or other feeding system. In this example, the base end (13) includes a male thread-form (22) and can be connected to the bottle, trough or other feeding system by engagement with a complimentary female thread-form. The base end (13) can be made of any suitable material, and to simplify the manufacturing process can be made of the same material that is used to make the body section (17) and the nipple end (15). At least a part of the body section (17) and of the nipple end (15) needs to be made of an elastomeric material that will allow flexing of the shape of the nipple end (15). And ideally, the elastomeric material is an elastomeric material that has a hardness, according to the Shore A hardness scale, of between forty and sixty.

An internal flow path (23) is provided in the artificial teat (11) that allows liquid to flow from the feeding device or system and through the base end (13), the body section (17) and to the nipple end (15). And, in this example the nipple end (15) includes five slits (19) that are aligned radially with respect to the principal axis (21). The five slits (19) are formed in the elastomeric material of the nipple end (15), and they allow liquid to pass through the nipple end (15) when the artificial teat (11) is suckled.

The slits (19) are each situated within a generally circular shaped valley (25) that is formed in the nipple end (15). The circular shaped valley (25) is centred about the principal axis (21) of the artificial teat (11), and it has a first general radius of curvature that is different to, or is in an opposing direction to, a radius of curvature of the parts of the nipple end (15) that surround, or which are surrounded by, the circular shaped valley (25).

In this example, it can be seen that the nipple end (15) has a central region (27) which is surrounded by the circular shaped valley (25), and which has a second general radius of curvature that that has a direction that is substantially opposite to the direction of the first general radius of curvature. The circular shaped valley (25) is in the form of a circular recessed channel having a concave curvature, when looking at the outer surface of the nipple end (15), and the central region (27) has a convex curvature when looking in the same direction.

It is the positioning of the uneven number of radially aligned slits (19) in the circular shaped valley (25) that gives the artificial teat (11) it's functional advantages. No matter how the teat (11) is aligned with respect to the suckling action, one of the slits (19) will be aligned with the suckling direction, or close to it. In some cases, two slits (19) may each be partially aligned. The suckling action squeezes the nipple end (15), causing a buckling of the elastomeric material that it is made of. The buckling will be most pronounced about any slits (19) that are generally aligned with the direction of the squeezing action.

This local buckling tends to cause the sides of the affected slits (19) to bow outwards, or to move away from one another, and allows a flow path to be opened. The slits (19) that are more transverse to the squeezing action tend to become more firmly closed. The positioning of the slits within the curvature of the circular shaped valley (25) helps to accentuate the buckling and the amount that the slits (19) open when the nipple end (15)

The inventor has found that an artificial teat (11) having five or seven radially aligned slits, that are equally spaced about the circular shaped valley (25), gives relatively consistent milk flow rates for all orientations of the teat (11) about its principal axis (21). Either one slit (19) is aligned closely to the squeezing action and provides a suitable milk flow rate, or two slits (19) are reasonably close to alignment, and the two slits (19) in combination allow a similar milk flow rate compared to the one closely aligned slit (19).

In situations where a large number of animals are being fed using bottles, and the bottles are simply dropped into bottle holders on the side of the animal enclosures, there is no time to ensure correct alignment of slits on the teats of the bottles with the suckling action of the animals. And in any case, a young animal may often tilt its head to one side while sucking. These difficulties in achieving optimum slit alignment are overcome by this new teat design.

Also, when multiple animals are housed within each enclosure, the uniform feeding rate that can be achieved with this new teat design, helps considerably in reducing the cross suckling that so often occurs when one animal finishes their bottle of milk before other animals within the same enclosure.

The nipple end (15) of the artificial teat (11) has internal webs (29). The webs (29) are in the form of projecting internal walls that extend from an inside surface of the nipple end (15) and toward the base end (13). The internal webs (29) intersect and form a polygon having the same number of sides as the number of slits (19) in the nipple end (15, in this case a five-sided polygon. The internal webs (29) span generally from one half of the inside of the nipple end (15) to an opposing half of the inside of the nipple end (15).

The nipple end (15) of the artificial teat (11) has internal webs that pass through the locations of each of the radial slits (19). The internal webs (29) that pass through the locations of each of the radial slits (19) are each aligned at right angles to a length of the slit (19) associated to that internal web (29). The slits (19) are cut through the layer of elastomeric material that forms the outer surface of the nipple end (15) and into the elastomeric material that forms the adjacent internal web (29). The slits (19) do not extend to a free edge of the internal webs (29).

The artificial teat (11) has a number of slit assist members, or tear stopping members. In this example, the artificial teat has a centrally located slit assist member (31) that is situated in the central region (27) of the nipple end (15). The central region (27) has a thicker total wall thickness when compared to the wall thickness of the remainder of the nipple end (15). The thicker total wall thickness of the central region (27) is made up of a layer of the elastomeric material that forms the nipple end (15), and the centrally located slit assist member (31). The slits (19) in the nipple end (15) do not extend inwardly to the centrally located slit assist member (31).

The artificial teat (11) is formed by over-moulding the nipple end (15), and at least a part of the body section (17), over the centrally located slit assist member (31). The centrally located slit assist member (31) is in the form of a substantially circular preformed member that is joined to the central region (27) during the manufacture of the artificial teat (11) which includes the over-moulding process.

The artificial teat (11) also includes slit assist members in the internal webs. A web slit assist member (33) is situated along a free edge of each of the internal webs (29), and each web slit assist member (33) is joined to the remainder of its associated web (29) during the over-moulding process that is used to manufacture each artificial teat (11). Each web slit assist member (33) is pre-tensioned during the time that the remainder of the nipple end (15) and the internal webs (29) are over-moulded about them.

Each slit assist member (31 or 33) is configured to assist in keeping one or more of the slits (19) closed, and to assist by acting as a tear stopping device to slow down or stop the slits (19) from tearing and increasing in size when the artificial teat (11) is in use. Each slit assist member (31 or 33) is made from the same, or a similar, elastomeric material as the remainder of the nipple end (15).

### SECOND EXAMPLE

With reference to FIGS. 6 to 9, a second example of an artificial teat (51) according to the present invention will now be described. A nipple end (53) of the second example of an artificial teat (51) is essentially the same as the nipple end (15) of the first example of an artificial teat (11).

A primary difference between the second example of an artificial teat (51) and the first example of an artificial teat (11) is the configuration of a base end (55) of the second example of an artificial teat (51). Instead of the male thread form used in the first example, the base end (55) has a female socket (56) that is designed to snap over a male spigot on a bottle, feeding trough or other feeding system.

The entrance of the female socket includes an inner lip (57) that must be stretched to fit over the male spigot, to facilitate the snap-on fitment and to help create a seal between the teat (51) and the opening of a bottle, or a spigot on a feeding trough, etc. As with the first example (11), the second example (51) is ideally made entirely of an elastomeric material, preferably having Shore A hardness of between forty and sixty.

As in the first example, the nipple end (53) of the second example of an artificial teat (51) includes a circular shaped valley (59) that contains five slits (61). And a raised or convex shaped central region (63) is surrounded by the circular shaped concave valley (59) and the five slits (61). The central region (63) again includes a small circular slit assist member (65) that helps to prevent the slits (61) from growing toward the centre of the nipple and (53) and to help keep the slits (61) closed.

And again, the nipple end (53) includes internal webs (67) that help to keep the slits (61) closed, and the webs (67) include web slit assist members (69) that can be pre-tensioned during teat manufacture to further help in keeping the slits (61) closed, and to prevent the slits (61) from extending to the free edge of the webs (67) over time.

### THIRD EXAMPLE

With reference to FIGS. 10 to 13, a third example of an artificial teat (81) according to the present invention will now be described. The third example of an artificial teat (81) is similar in many respects to the first and second examples of an artificial teat (11 & 51) except as follows. A primary difference between the third example of an artificial teat (81) and the first and second examples of an artificial teat (11 & 51) is the configuration of a number of slits (83) and their associated webs (95).

As in the first and second examples, the third example of an artificial teat (81) has a nipple end (87) and a base end (89). The nipple end (87) of the third example of an artificial teat (81) includes a circular shaped valley (91) that contains five slits (83). And a raised or convex shaped central region (93) is surrounded by the circular shaped concave valley (91) and the five slits (83).

As can be seen in FIG. 11, the nipple end (87) includes five radially aligned internal webs (95) that help to keep the slits (83) closed. Although not shown in FIGS. 10 to 13, the internal webs (95) can also include a web slit assist members similar to those described in the first and second examples described herein, and for the same purpose.

A key difference in the third example of an artificial teat (81) is that the slits (83) are not aligned radially, but instead are aligned in a substantially circumferential direction. The slits (83) lie generally in the bottom of the circular shaped valley (91), and could be said to each lie in a direction that is tangential to a circle that is formed by the base or bottom of the circular shaped valley (91).

The internal webs (95) are each aligned in a radial direction. Each internal web (95) extends from a principal axis (97) of the teat (81) and out to a cylindrical sidewall (99) of a body portion (101) of teat (81). The slits (83) lie in a circular pattern that is centred about the principal axis (97) of the teat (81), and are each aligned at right angles to the internal web (95) that is associated with each slit (83).

As with the first and second examples, no matter how the teat (81) is aligned with respect to the suckling action of a baby or young animal, one of the slits (83) will be aligned with the suckling direction, or be in close alignment. In some cases, two slits (83) may each be partially aligned. The suckling action squeezes the nipple end (87), causing a buckling of the elastomeric material that it is made of. The buckling will be most pronounced about any slits (83) that are generally aligned with the direction of the squeezing action. In this way, the teat (81) is able to provide a relatively uniform milk flow rate at any orientation of the slits (83) relative to the suckling action.

The position of the slits (83) at the bottom of the circular shaped valley (91), and their general alignment with the base of the circular shaped valley (91), helps to ensure positive buckling and opening of the slits (83) that are aligned with the suckling action.

### Common Features

In each of the three examples described herein, the artificial teat (11, 51 or 81) has five slits, and each slit is aligned at an angle of approximately seventy-two degrees, or approximately one hundred and eight degrees, to two of the other slits. It is envisaged that each slit should be aligned at an angle in the range of sixty-five to eighty degrees, to two of the other slits, for the artificial teat (11, 51 or 81) to work effectively in providing a consistent flow of milk to a baby or young animal, irrespective of teat orientation.

### VARIATIONS

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

In the examples described herein, the nipple end (15, 53 or 83) includes a circular shaped valley that contains the slits. It is envisaged that in an alternative embodiment, the nipple end (15, 53 or 83) could include a circular shaped ridge that contains the slits. In such a case, the circular shaped ridge would surround a concave shaped central region.

In the first example described herein, the central region (27) that is surrounded by the circular shaped valley (25), has a curved convex shape. It is envisaged that an alternative embodiment the central region (27) may have more of a conical convex shape.

In addition to the two examples described herein, the inventor also plans to make a training teat that has no internal webs. This training would possibly have seven slits to make it easier for an infant to feed, and also to feed faster. This training teat would be used for a few days after birth only.

### Definitions

Throughout this specification the word “comprise” and variations of that word, such as “comprises” and “comprising”, are not intended to exclude other additives, components, integers or steps.

### Advantages

Thus, it can be seen that at least the preferred form of the invention provides an artificial teat which has a configuration of slits that provides relatively consistent milk flow rates irrespective of the orientation of the teat relative to the suckling action of an infant or young animal.

The more consistent and controlled flow rates help with the health and growth of the infants and young animals during their initial weeks of life.

In addition, the consistent milk flow rates assist in situations where more than one animal is housed together, improving the chances that each animal will finish their bottle of milk at about the same time, and minimising the problems associated with cross suckling.

With a traditional cross (X) slit or a single slit, the slit or slits open each time a teat is compressed while suckling. This repeated opening of the slit can cause the slit to “grow” with the continued pressure applied at the ends of the slit or slits. When teats are regularly removed for washing, they are generally reinstalled (reinstated) in a random orientation. And so, with this new design, the usual suckling pressure will be on the ends of a different slit or pair of slits after each wash. Over time the wear is evenly spread over all slits and the service life of the teat is much greater than with traditional cross slit or single slit teats.

1. An artificial teat or nipple for feeding infants or newborn animals, the artificial teat having a base end, a nipple end, and a body section that is situated between the base end and the nipple end; and the artificial teat has a principal axis that passes through a centre of the base end and a centre of the nipple end; and at least part of the body section and of the nipple end is made of an elastomeric material; and the base end is configured so that the artificial teat is connectable to a feeding device or system, and an internal flow path is provided in the artificial teat to allow liquid to flow from the feeding device or system and through the body section to the nipple end; and the slits are each situated within a generally circular shaped valley or ridge that is formed in the nipple end.

2. The artificial teat or nipple as claimed in claim 1, wherein the said generally circular shaped valley or ridge that is formed in the nipple end is centred about the principal axis of the artificial teat.

3. The artificial teat or nipple as claimed in claim 1, wherein the said generally circular shaped valley or ridge has a first general radius of curvature that is different to, or is in an opposing direction to, a radius of curvature of the parts of the nipple end that surround, or which are surrounded by, the said generally circular shaped valley or ridge.

4. The artificial teat or nipple as claimed in claim 3, wherein the nipple end has a central region which is surrounded by the said generally circular shaped valley or ridge, and the central region of the nipple end has a second general radius of curvature or has a conical shape.

5. The artificial teat or nipple as claimed in claim 4, wherein a first direction of curvature of the said generally circular shaped valley or ridge is substantially opposite to a second direction of curvature of the central region.

6. The artificial teat or nipple as claimed in claim 4, wherein the said generally circular shaped valley or ridge is concave if the central region is convex, or the said generally circular shaped valley or ridge is convex if the central region is concave.

7. The artificial teat or nipple as claimed in claim 1, wherein the said generally circular shaped valley or ridge is in the form of a circular recessed channel having a concave curvature, when looking at the outer surface of the nipple end of the artificial teat.

8. The artificial teat or nipple as claimed in claim 1, wherein the nipple end includes a plurality of slits that are each aligned in a substantially circumferential direction.

9. The artificial teat or nipple as claimed in claim 1, wherein the nipple end includes a plurality of slits that each lie in a direction that is tangential to a circle that is formed by the base or bottom of the circular shaped valley, or to a circle that is formed by the crest of the circular shaped ridge.

10. The artificial teat or nipple as claimed in claim 1, wherein the nipple end includes a plurality of slits that lie generally in the bottom of the generally circular shaped valley, or in the crest of the generally circular shaped ridge, that is formed in the nipple end.

11. The artificial teat or nipple as claimed in claim 1, wherein the nipple end includes a plurality of slits that lie in a circular pattern that is centred about the principal axis of the artificial teat.

12. The artificial teat or nipple as claimed in claim 1, wherein the nipple end includes a plurality of slits that are aligned radially with respect to the principal axis.

13. The artificial teat or nipple as claimed in claim 1, wherein the artificial teat has an uneven number of slits.

14. The artificial teat or nipple as claimed in claim 1, wherein the artificial teat has five or seven slits.

15. The artificial teat or nipple as claimed in claim 1, wherein the artificial teat has five slits, and each slit is aligned at an angle in the range of sixty-five to eighty degrees, to two of the other slits.

16. The artificial teat or nipple as claimed in claim 1, wherein the artificial teat has five slits, and each slit is aligned at an angle of approximately seventy-two degrees, or approximately one hundred and eight degrees, to two of the other slits.

17. The artificial teat or nipple as claimed in claim 1, wherein the nipple end of the artificial teat has internal webs, and the internal webs are in the form of projecting internal walls that extend from an inside surface of the nipple end and toward the base end.

18. The artificial teat or nipple as claimed in claim 17, wherein the slits are cut through the layer of elastomeric material that forms the outer surface of the nipple end and into the elastomeric material that forms the adjacent internal web or webs.

19. The artificial teat or nipple as claimed in claim 1, wherein the artificial teat has at least one slit assist member, or tear stopping member.

20. A feeding device or system incorporating at least one artificial teat substantially as claimed in claim 1.
